(19) United States
(12) Patent Application Publication
(10) Pub. No.: US 2022/0172168 A1
(43) Pub. Date: Jun. 2, 2022

(54) CONFLICT RESOLUTION IN DESIGN PROCESS USING VIRTUAL AGENTS

(71) Applicant: International Business Machines Corporation, Armonk, NY (US)

(72) Inventors: Kushagra Manglik, Lucknow (IN); Vijay Ekambaram, Chennai (IN); Surya Shravan Kumar Sajja, Bangalore (IN); Nupur Aggarwal, Bangalore (IN); Vikas C. Raykar, Bangalore (IN); Akshay Gugnani, New Delhi (IN)

(21) Appl. No.: 17/107,061

(22) Filed: Nov. 30, 2020

(51) Int. Cl. G06Q 10/10; G06F 21/64; G06Q 50/04; G06Q 50/28; G06Q 10/06; G06Q 30/06; G06Q 50/18; G06Q 30/02

(52) U.S. Cl. CPC G06Q 10/101; G06F 21/64; G06Q 50/04; G06Q 50/28; G06F 30/10; G06Q 30/0621; G06Q 50/182; G06Q 30/0201; G06Q 10/067

(57) ABSTRACT

One embodiment provides a computer implemented method, including: creating a buyer and manufacturer virtual agent representing a buyer and manufacturer within a design supply chain; creating a designer virtual agent representing a designer within the design supply chain; detecting a conflict between design attributes preferred by the buyer and manufacturer and design attributes preferred by the designer for a product being designed by the designer; resolving, utilizing the buyer and manufacturer virtual agent and the designer virtual agent, the conflict via initiating a conversation between the buyer and manufacturer virtual agent and designer virtual agent to generate attribute suggestions for incorporation into the product; and presenting the attribute suggestions to the designer for incorporation into the product.

### BACKGROUND

Designing products for retail sale includes more than a designer simply creating a product. Rather, multiple people are involved in the design process. The design process includes, in addition to the designer, a manufacturer and a buyer of products. When the designer designs a product, the designer may take inspiration from multiple sources, but ultimately designs a product that the designer wants to design. However, either or both the buyer and manufacturer may not agree with design attributes of the product. Instead of inspiration, the buyer and manufacturer rely on historical sales trend data to drive ideas regarding design attributes. Many times the preferred design attributes of the buyer and manufacturer are not the same as the preferred design attributes of the designer. The buyer and manufacturer attempt to convince the designer to change design attributes in order to create a product that the buyer and manufacturer believe will sell better than the original design by the designer.

### BRIEF SUMMARY

In summary, one aspect of the invention provides a computer implemented method, including: creating a buyer and manufacturer virtual agent representing a buyer and manufacturer within a design supply chain; creating a designer virtual agent representing a designer within the design supply chain; detecting a conflict between design attributes preferred by the buyer and manufacturer and design attributes preferred by the designer for a product being designed by the designer; resolving, utilizing the buyer and manufacturer virtual agent and the designer virtual agent, the conflict via initiating a conversation between the buyer and manufacturer virtual agent and designer virtual agent to generate attribute suggestions for incorporation into the product; and presenting the attribute suggestions to the designer for incorporation into the product.

Another aspect of the invention provides an apparatus, including: at least one processor; and a computer readable storage medium having computer readable program code embodied therewith and executable by the at least one processor; wherein the computer readable program code is configured to create a buyer and manufacturer virtual agent representing a buyer and manufacturer within a design supply chain; wherein the computer readable program code is configured to create a designer virtual agent representing a designer within the design supply chain; wherein the computer readable program code is configured to detect a conflict between design attributes preferred by the buyer and manufacturer and design attributes preferred by the designer for a product being designed by the designer; wherein the computer readable program code is configured to resolve, utilizing the buyer and manufacturer virtual agent and the designer virtual agent, the conflict via initiating a conversation between the buyer and manufacturer virtual agent and designer virtual agent to generate attribute suggestions for incorporation into the product; and wherein the computer readable program code is configured to present the attribute suggestions to the designer for incorporation into the product.

An additional aspect of the invention provides a computer program product, including: a computer readable storage medium having computer readable program code embodied therewith, the computer readable program code executable by a processor; wherein the computer readable program code is configured to create a buyer and manufacturer virtual agent representing a buyer and manufacturer within a design supply chain; wherein the computer readable program code is configured to create a designer virtual agent representing a designer within the design supply chain; wherein the computer readable program code is configured to detect a conflict between design attributes preferred by the buyer and manufacturer and design attributes preferred by the designer for a product being designed by the designer; wherein the computer readable program code is configured to resolve, utilizing the buyer and manufacturer virtual agent and the designer virtual agent, the conflict via initiating a conversation between the buyer and manufacturer virtual agent and designer virtual agent to generate attribute suggestions for incorporation into the product; and wherein the computer readable program code is configured to present the attribute suggestions to the designer for incorporation into the product.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of resolving conflicts within a design process for a product being designed by a designer utilizing virtual agents generated for and corresponding to both a buyer and manufacturer and a designer.

FIG. 2 illustrates an example explanation and illustration presented to a designer after conflict resolution.

FIG. 3 illustrates an example overall system architecture for resolving conflicts within a design process for a product being designed by a designer utilizing virtual agents generated for and corresponding to both a buyer and manufacturer and a designer.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

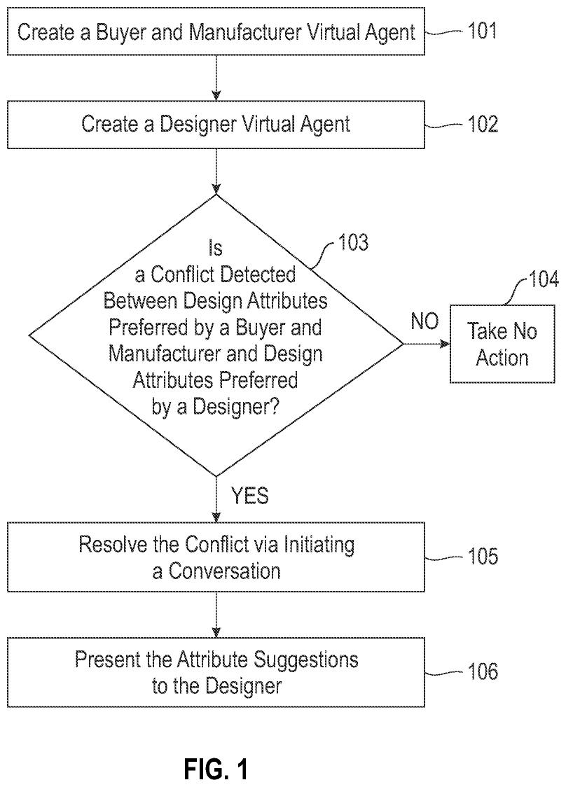

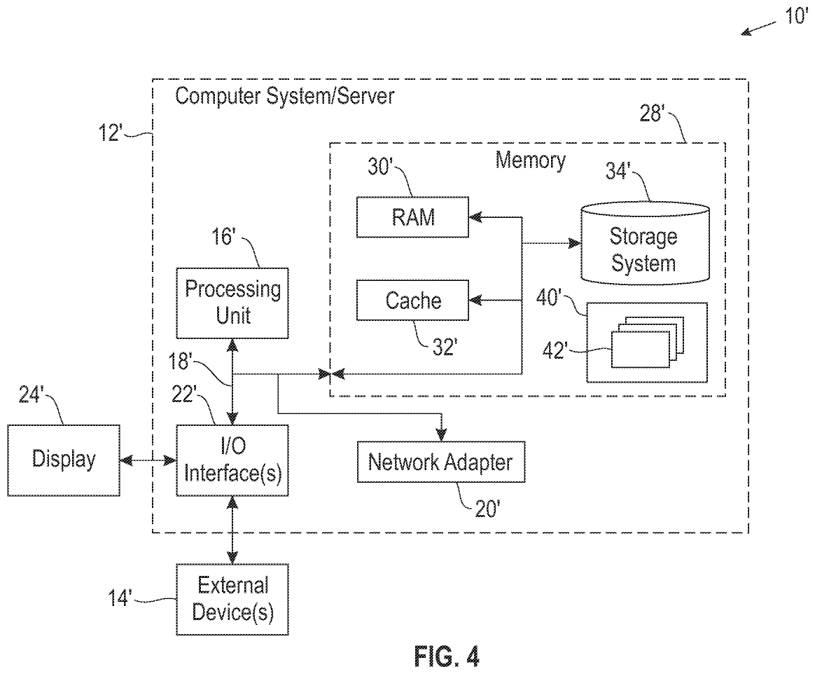

Specific reference will be made here below to FIGS. 1-4. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 4, whether on a server computer, a client computer, a node computer in a distributed network, or any combination thereof.

Since the buyer and manufacturer cannot offer opinions regarding the design of a product until a rendering or sample of the product is generated by the designer, the design process and, particularly, the back-and-forth between the buyer and manufacturer and the designer requires many iterations taking significant amounts of time. When the designer receives feedback from the buyer and manufacturer, the designer generates new renderings or samples incorporating the feedback and presents these new renderings to the buyer and manufacturer. If the buyer and manufacturer have additional comments or feedback on the new renderings or samples, this feedback is again provided to the designer for incorporation. This process continues until both the designer and buyer and manufacturer are satisfied with the final product. This process can be very time consuming and increases the time to market for products. The increase in time to market can result in lost profits, lost market shares, lost customers, and the like, therefore, being very detrimental to the product market process.

Accordingly, an embodiment provides a system and method for resolving conflicts within a design process for a product being designed by a designer utilizing virtual agents generated for and corresponding to both a buyer and manufacturer and a designer. The system creates a buyer and manufacturer virtual agent representing a buyer and manufacturer in a design supply chain. Additionally, the system creates a designer virtual agent to represent the designer in the design supply chain. As the designer designs a product, the virtual agents monitor the product and detect design attributes associated with the product. Since the buyer and manufacturer and the designer have different sources that drive a design of the product, the buyer and manufacturer and designer will have conflicts regarding what the final attributes of a product should be. Accordingly, as the virtual agents monitor the product and, specifically, the design of the product, the system monitors to determine if a conflict between the virtual agents occur. The conflict occurs between design attributes preferred by the buyer and the manufacturer and design attributes preferred by the designer.

Instead of involving the actual buyer and manufacturer and the designer, the virtual agents resolve the conflict via initiation of a conversation between the virtual agents. The conversation occurs in view of any constraints and or target values or ranges for particular key performance indicators. Each of the virtual agents generates an attribute suggestion utilizing an algorithm that identifies an effect of different product attributes on a particular performance indicator in view of input that is unique to the virtual agent. For example, the buyer and manufacturer virtual agent performs the analysis in view of historical sales trend data, whereas the designer virtual agent may perform the analysis in view of current trends. The attribute suggestions are then presented to the designer for incorporation into the product. The presentation may include an explanation for why a particular attribute is being suggested and may also include an illustration that illustrates the effect of incorporation of a particular attribute on the overall key performance indicator for the product. Once the designer incorporates the suggestions, the design may be presented to the buyer and manufacturer for the first time and being closer to a final design than in conventional systems.

Such a system provides a technical improvement over current systems for a design process. Instead of relying on the time consuming traditional technique where the designer and buyer and manufacturer engage in multiple communications and iterations for resolving design conflicts, the described system and method can automatically engage in a conflict resolution process utilizing virtual agents representing each of the buyer and manufacturer and the designer. These virtual agents can engage in a conversation where attributes for a product design are chosen by each of the virtual agents. Once the agents have resolved the conflict, the system can present these suggested attributes to the designer who can incorporate the attributes. The designer can present this product design to the buyer and manufacturer for approval. Thus, instead of multiple iterations and conversations between the designer and the buyer and manufacturer, the described system provides a technique for significantly reducing these iterations. Such a system, therefore, is more efficient and less time intensive than conventional methods which reduces the time for a product to make it to market.

FIG. 1 illustrates a method for resolving conflicts within a design process for a product being designed by a designer utilizing virtual agents generated for and corresponding to both a buyer and manufacturer and a designer. A fashion design supply chain will be the primary example used herein. However, the described system can be applied to any design supply chain that includes at least two parties that may have conflicting views regarding attributes of the product being designed. For example, the described system can be applied to a jewelry design supply chain, website design supply chain, architecture design supply chain, recipe design supply chain, or the like. Accordingly, any examples used here throughout directed to a particular design supply chain are not intended to limit the scope of this disclosure in any way.

At 101 the system creates a buyer and manufacturer virtual agent to represent a buyer and manufacturer in a design supply chain. In creating the buyer and manufacturer (B&M) virtual agent, the system utilizes inputs that are typical inputs that would influence attributes chosen by a B&M. Using the example of the fashion design supply chain, the B&M may be influenced by historical sales history data, for example, brand sentiment from sales history, attribute weighting on historical product sales, and the like. The B&M may also be influenced by decisions made by other designers in designing similar products. The system can also identify and utilize other inputs that may influence a B&M.

The system utilizes an algorithm to learn from the inputs in order to identify the effect of different attributes on different target variables. For example, the system may leverage a Markov decision process paradigm to solve the imitation learning problem where the virtual agent tries to learn from the inputs, in this case, the historical sales history data, other designer decisions, and the like. From the learning, the virtual agent can learn various functions that map the effect of a product attribute on different target variables. The target variables may be key performance indicators, constraints provided by a user, and the like. The learned functions can then be utilized by the virtual agent in later steps to detect conflict between preferred design attributes and also to generate attribute suggestions.

At 102 the system creates a designer virtual agent that represents the designer within the design supply chain. The creation of the designer virtual agent is performed utilizing the same technique as used to create the B&M virtual agent. The difference in the two virtual agents is the input. Rather than the inputs utilized in creating the B&M virtual agent, the system utilizes inputs that would influence attributes selected by the designer for creating the designer virtual agent. Examples of such inputs in the fashion design supply chain may include social media trends, runway trends, fashions found in magazines or catalogs, any other current product trend data, or the like. Since the inputs are different, the learned functions will result in different effects, even though the process for generating the learned functions is the same between creation of the virtual agents. Additionally, the functions will be created for the same key performance indicators and/or constraints across all virtual agents. The example of two virtual agents is used here throughout, however, it should be understood that similar processes can be used to generate more than two virtual agents in the event that a design supply chain has more than two entities that need to be represented by virtual agents.

At 103 the system determines a conflict is detected between design attributes preferred by the buyer and the manufacturer and design attributes preferred by the designer for a product being designed by the designer. As the designer designs a product and pushes the product, the virtual agents (B&M and designer virtual agents) monitor for new product designs. When a new product design is detected by the virtual agents, the virtual agents analyze the attributes included in the design. Monitoring for a new design may include monitoring an application that the designer utilizes for creating product designs. In other words, the virtual agents may be add-ons or otherwise operatively coupled to a design application utilized by the designer.

The virtual agents analyze the attributes in view of the corresponding functions generated by each agent. If the analysis indicates that a modification should be made to the attributes, the system may identify this as a design conflict. Another technique for detecting a conflict may be identifying that a difference is found between the inputs for the B&M virtual agent and the designer virtual agent. In other words, for example, the system may identify that the historical sales data would indicate that one attribute should be utilized, whereas the current trend data would indicate a different attribute should be utilized. Thus, based upon the analysis performed by the virtual agents, the system can determine whether a conflict between the B&M and designer regarding product attributes would occur. This process negates the need for the designer to submit the design to the B&M, as in conventional techniques. Instead, the virtual agents can identify the potential conflict(s) and attempt to resolve the conflict(s) before the B&M is introduced to the product design.

If no conflict is detected at 103, the system may take no action at 104. If, on the other hand, a conflict is detected at 103, the system may resolve the conflict utilizing the B&M virtual agent and the designer virtual agent by initiating a conversation between the B&M virtual agent and the designer virtual agent. The result of the conversation is an aggregate of the attribute suggestions made by each of the virtual agents. In resolving the conflict, the virtual agents factor into account a set of design constraints that are provided by a user, are default constraints, or the like. The design constraints may be related to target variables, for example, key performance indicators (e.g., sale through rate, diversity indices, sustainability indices, a threshold number of products having certain attributes, etc.), expected sales numbers, a predetermined or threshold number of attribute changes, or the like. The design constraints may be different based upon the industry or design supply chain the system is being utilized within.

The conflict resolution process occurs with respect to each of a plurality of target variables. In other words, the conflict resolution process is an iterative process where the process is performed for a first target variable, performed again for a second target variable, performed again for a third target variable, and so on until the process has been performed for all the desired target variables. The result is a plurality of attribute suggestions, at least one for each target variable. The resolution process begins with each virtual agent receiving a feature vector for the new product design that was received from the designer. The feature vector represents the different attributes of the product design in vector format. For example, using the fashion example, the feature vector may include a feature for the fabric type, fabric color, pattern, price, occasion, sleeve length, color hue, color saturation, color value, or the like.

Each virtual agent utilizes the same feature vector for the product design. However, each agent uses the function corresponding to the target variable for the corresponding virtual agent as learned when creating the virtual agent. In other words, the functions learned by each virtual agent for a target variable and learned while creating the virtual agent will be used in conjunction with the feature vector for the product design by each virtual agent. Each virtual agent maps the feature vector to the target variable using the function for the virtual agent. Each virtual agent makes the minimum changes to the feature vector to make a new feature vector that is as close to the target value of the target variable as possible. In other words, each virtual agent generates a new feature vector by minimally modifying the initial product feature vector in view of the target variable. This results in two new feature vectors, one for each virtual agent. The system aggregates the two feature vectors to create a combined feature vector.

In aggregating the feature vectors received from each virtual agent, the system applies a weighting to the feature vectors generated by each of the virtual agents. To determine what weighting should be applied to each feature vector the system utilizes past conversation logs to calculate a hit ratio for each virtual agent. The hit ratio indicates how successful each virtual agent is with respect to past attribute suggestions. In other words, the hit ratio provides an indication of how frequently an attribute suggestion made by a virtual agent is incorporated into and kept within the final design of a product, thereby indicating an attribute suggestion that is more correct as compared with an attribute suggestion by another virtual agent. Attribute suggestions that are not incorporated into final designs reduce the hit ratio of a virtual agent, whereas attribute suggestions that are incorporated into final designs increase the hit ratio of a virtual agent. Attribute suggestions by a virtual agent having a higher hit ratio are weighted higher so these attribute suggestions are more likely to be incorporated into the final design.

The hit ratios can then be used as the weightings for the feature vectors created by the system to aggregate the virtual agent feature vectors into a final feature vector. The final feature vector represents the attribute suggestions by the virtual agents that are the result of the conflict resolution process. As mentioned before, the system generates a plurality of attribute suggestions, each based upon different target variables. The attribute suggestions are then presented to the designer for incorporation into the product at 106. Presenting the attribute suggestions to the designer may include providing an explanation for the attribute suggestions in view of a target variable. In other words, the system may provide an explanation that explains how an attribute suggestion affects a target variable as compared to the original target variable value corresponding to the original product design. The presentation of the attribute suggestions may also include providing an illustration that illustrates an effect of incorporating an attribute suggestion on the target variable.

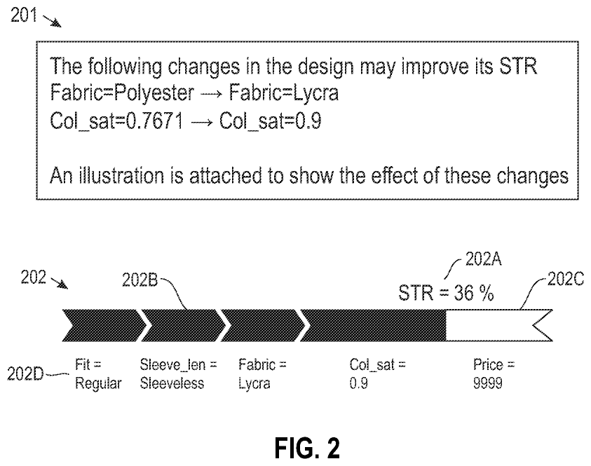

An example presentation of attribute suggestions is illustrated in FIG. 2. 201 illustrates an example explanation that identifies the effect of implementing an attribute suggestion on the target variable sell through rate (STR). FIG. 2 also illustrates an example illustration 202 in the form of a Shap plot. The target variable is identified at 202A. The attributes affecting the target variable 202A are identified at 202D. Those attributes on the left side of the plot represented by the red portions 202B are attributes that increase the target variable 202A. Those attributes on the right side of the plot represented by the blue portions 202C are attributes that decrease the target variable 202A. In this example, the attributes fit, sleeve length, fabric, and color saturation are increasing the STR, whereas the price is decreasing the STR. Bigger attribute portions represent attributes that have a bigger effect on the target variable than those attributes represented by smaller portions.

The designer can incorporate one or more of the attribute suggestions into the product design. Once the designer has incorporated the selected attribute suggestions the new product design can be provided to the actual B&M for the first time. This design will be closer to a final design version due to the conflict identification and resolution by the virtual agents, thereby reducing the number of communications that must occur between the designer and the B&M. Once the product design is finalized, the attributes incorporated into the final design can be utilized to provide feedback into the system, for example, by updating the hit ratios and the suggestion weightings for the virtual agents.

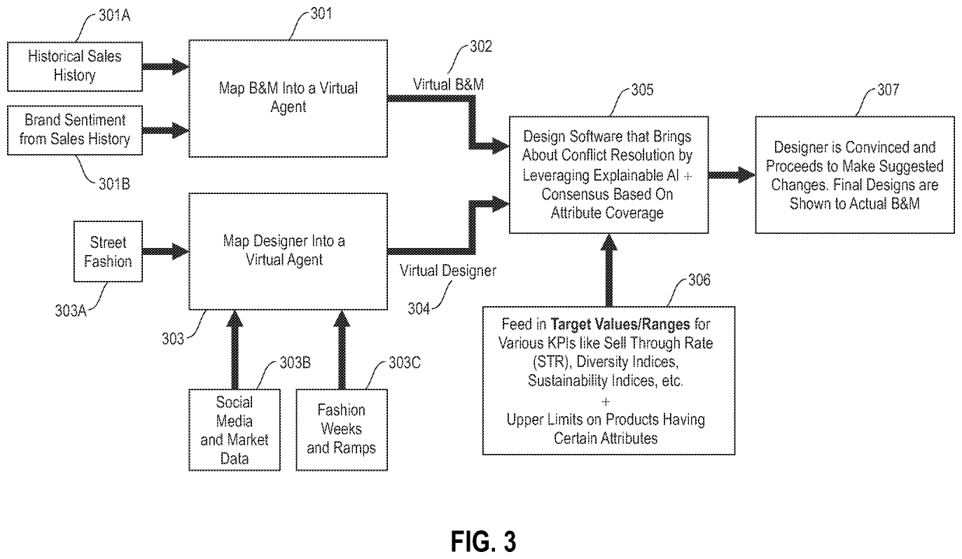

FIG. 3 illustrates an example overall system architecture of the described system and method. The buyer and manufacturer (B&M) is mapped into a virtual agent at 301. This mapping uses inputs that would influence the B&M, for example, historical sales history data 301A, brand sentiment from sales history 301B, and the like. The mapping results in a virtual B&M 302. Similarly, the designer is mapped into a virtual agent at 303. This mapping uses inputs that would influence the designer, for example, street fashion trends 303A, social media and market data 303B, fashion weeks and ramps trends 303C, and the like. The mapping results in a virtual designer 304. At 305, software is created to bring about conflict resolution that leverages explainable artificial intelligence and consensus based on attribute coverage. The conflict resolution is performed in view of constraints 306 that include target values or ranges for various constraints, for example, key performance indicators (KPIs) (e.g., sell through rate (STR), diversity indices, sustainability indices, etc.), threshold limits on products having certain attributes, and any other constraints. The result of the conflict resolution is attribute suggestions that are provided to the designer. At 307 the designer is convinced of suggestion incorporations, proceeds to make the changes, and provides the final design to the actual B&M.

As shown in FIG. 4, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method, comprising:
creating a buyer and manufacturer virtual agent representing a buyer and manufacturer within a design supply chain;
creating a designer virtual agent representing a designer within the design supply chain;
detecting a conflict between design attributes preferred by the buyer and manufacturer and design attributes preferred by the designer for a product being designed by the designer;
resolving, utilizing the buyer and manufacturer virtual agent and the designer virtual agent, the conflict via initiating a conversation between the buyer and manufacturer virtual agent and designer virtual agent to generate attribute suggestions for incorporation into the product; and
presenting the attribute suggestions to the designer for incorporation into the product.

2. The computer implemented method of claim 1, wherein the creating a buyer and manufacturer virtual agent comprises obtaining historical sales data corresponding to products having identified attributes and generating a plurality of functions, each of the plurality of functions corresponding to a target variable and being generated based upon the historical sales data.

3. The computer implemented method of claim 1, wherein the creating a designer virtual agent comprises obtaining current product trend data corresponding to products having identified attributes and generating a plurality of functions, each of the plurality of functions corresponding to a target variable and being generated based upon the current product trend data.

4. The computer implemented method of claim 1, wherein the resolving comprises generating a final feature vector corresponding to a target variable, wherein the final feature vector is generated from a designer virtual agent feature vector corresponding to the target variable and a buyer and manufacturer virtual agent feature vector corresponding to the target variable.

5. The computer implemented method of claim 4, wherein the resolving comprises each of the designer virtual agent and buyer and manufacturer virtual agent generates a corresponding feature vector by minimally modifying an initial product feature vector in view of the target variable.

6. The computer implemented method of claim 1, wherein the resolving is performed in view of design constraints related to target variables and provided by a user.

7. The computer implemented method of claim 1, wherein the resolving comprises receiving attribute suggestions from each of the buyer and manufacturer virtual agent and the designer virtual agent and weighting each of the attribute suggestions based upon the virtual agent providing the attribute suggestion.

8. The computer implemented method of claim 7, wherein the weighting is based upon a success rate of each of the buyer and manufacturer virtual agent and the designer virtual agent.

9. The computer implemented method of claim 1, wherein the presenting comprises providing an explanation for the attribute suggestions in view of a target variable.

10. The computer implemented method of claim 1, wherein the presenting comprises providing an illustration that illustrates an effect of incorporating an attribute suggestion on a target variable.

11. An apparatus, comprising:
at least one processor; and
a computer readable storage medium having computer readable program code embodied therewith and executable by the at least one processor;
wherein the computer readable program code is configured to create a buyer and manufacturer virtual agent representing a buyer and manufacturer within a design supply chain;
wherein the computer readable program code is configured to create a designer virtual agent representing a designer within the design supply chain;
wherein the computer readable program code is configured to detect a conflict between design attributes preferred by the buyer and manufacturer and design attributes preferred by the designer for a product being designed by the designer;
wherein the computer readable program code is configured to resolve, utilizing the buyer and manufacturer virtual agent and the designer virtual agent, the conflict via initiating a conversation between the buyer and manufacturer virtual agent and designer virtual agent to generate attribute suggestions for incorporation into the product; and
wherein the computer readable program code is configured to present the attribute suggestions to the designer for incorporation into the product.

12. A computer program product, comprising:
a computer readable storage medium having computer readable program code embodied therewith, the computer readable program code executable by a processor;
wherein the computer readable program code is configured to create a buyer and manufacturer virtual agent representing a buyer and manufacturer within a design supply chain;
wherein the computer readable program code is configured to create a designer virtual agent representing a designer within the design supply chain;
wherein the computer readable program code is configured to detect a conflict between design attributes preferred by the buyer and manufacturer and design attributes preferred by the designer for a product being designed by the designer;
wherein the computer readable program code is configured to resolve, utilizing the buyer and manufacturer virtual agent and the designer virtual agent, the conflict via initiating a conversation between the buyer and manufacturer virtual agent and designer virtual agent to generate attribute suggestions for incorporation into the product; and
wherein the computer readable program code is configured to present the attribute suggestions to the designer for incorporation into the product.

13. The computer program product of claim 12, wherein the creating a buyer and manufacturer virtual agent comprises obtaining historical sales data corresponding to products having identified attributes and generating a plurality of functions, each of the plurality of functions corresponding to a target variable and being generated based upon the historical sales data.

14. The computer program product of claim 12, wherein the creating a designer virtual agent comprises obtaining current product trend data corresponding to products having identified attributes and generating a plurality of functions, each of the plurality of functions corresponding to a target variable and being generated based upon the current product trend data.

15. The computer program product of claim 12, wherein the resolving comprises generating a final feature vector corresponding to a target variable, wherein the final feature vector is generated from a designer virtual agent feature vector corresponding to the target variable and a buyer and manufacturer virtual agent feature vector corresponding to the target variable.

16. The computer program product of claim 12, wherein the resolving is performed in view of design constraints related to target variables and provided by a user.

17. The computer program product of claim 12, wherein the resolving comprises receiving attribute suggestions from each of the buyer and manufacturer virtual agent and the designer virtual agent and weighting each of the attribute suggestions based upon the virtual agent providing the attribute suggestion.

18. The computer program product of claim 17, wherein the weighting is based upon a success rate of each of the buyer and manufacturer virtual agent and the designer virtual agent.

19. The computer program product of claim 12, wherein the presenting comprises providing an explanation for the attribute suggestions in view of a target variable.

20. The computer program product of claim 12, wherein the presenting comprises providing an illustration that illustrates an effect of incorporating an attribute suggestion on a target variable.
